(19) United States
(12) Patent Application Publication
(10) Pub. No.: US 2013/0291091 A1
(43) Pub. Date: Oct. 31, 2013

(54) Location Bound Secure Domains

(71) Applicant: Motorola Mobility LLC, Libertyville, IL (US)

(72) Inventor: James B. McGuire, JR., Delray Beach, FL (US)

(21) Appl. No.: 13/931,895

(22) Filed: Jun. 29, 2013

Related U.S. Application Data
(63) Continuation-in-part of application No. 11/967,592, filed on Dec. 31, 2007.

(51) Int. Cl. G06F 21/44

(52) U.S. Cl. CPC G06F 21/44
USPC 726/17

(57) ABSTRACT

A telecommunications apparatus has secure operation based on geographic location. A positioning mechanism determines a geographic location for the telecommunications apparatus. A processor identifies a secure domain and determines an availability of an application programming interface for the based on the geographic location, wherein at certain geographic locations access to the application programming interface is restricted, and at other geographic locations access to the application programming interface is unrestricted.

### CROSS REFERENCE TO RELATED APPLICATION

The present application is a continuation of co-pending U.S. application Ser. No. 11/967,592, filed on 31 Dec. 2007, from which benefits under 35 USC 120 are hereby claimed and the contents of which are incorporated herein by reference.

### FIELD OF THE INVENTION

The present invention relates to a method and system for secure operation of a virtual machine application on a mobile device. The present invention further relates to controlling access by the virtual machine application to application programming interfaces.

### INTRODUCTION

Java® Platform, Micro Edition (ME) is a subset of the Java specification directed towards resource-constrained environments, such as mobile computing devices, mobile telephones, handheld computers, and similar portable devices. One specification for the Java ME® is a mobile information device profile (MIDP). A virtual machine under the MIDP for mobile computing devices, referred to as a MIDlet, may be downloaded onto a mobile computing device. Including a signed electronic certificate may increase the security of executing these MIDlets.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a block diagram one embodiment of a handheld device that may be used to implement the communication protocol management method.

FIG. 2 illustrates in a block diagram one embodiment of a system for downloading a virtual machine application to a mobile computing device.

FIG. 3 illustrates in a block diagram one embodiment of a software configuration of a mobile computing device.

FIG. 4 illustrates in a block diagram one embodiment of a system for locating a mobile computing device.

FIG. 5 illustrates in a flowchart one embodiment of a method for certifying a virtual machine application for a mobile computing device based on location.

FIG. 6 illustrates in a flowchart one embodiment of a method for controlling access to an application programming interface based on location.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device with secure operation based on geography are disclosed. A positioning mechanism may determine a geographic location for the apparatus or electronic device. A processor may identify a secure domain for a virtual machine application. The processor may determine an availability of an application programming interface for the virtual machine application based on the geographic location.

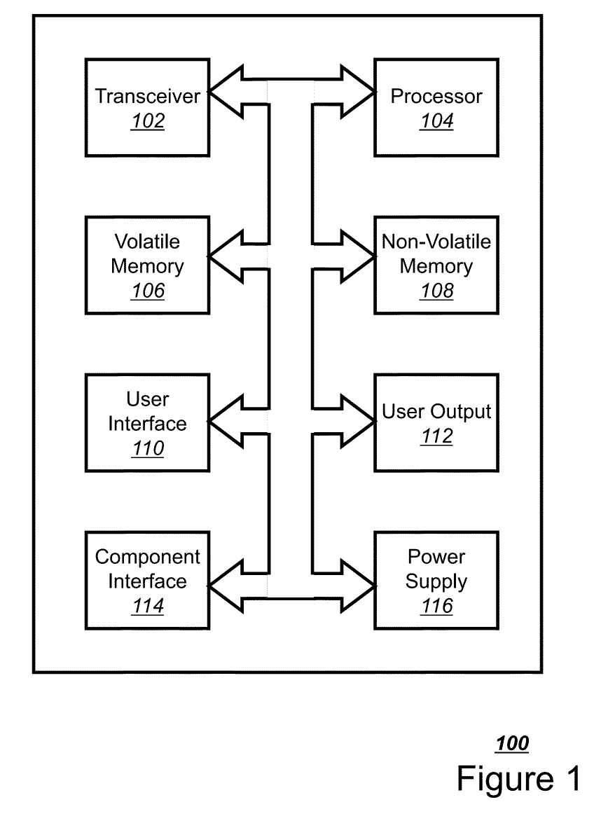

FIG. 1 illustrates in a block diagram one embodiment of a handheld device 100 that may be used to execute a virtual machine application. The handheld device 100 may access the information or data stored in a network. The handheld device 100 may support one or more applications for performing various communications with the network. The handheld device 100 may implement any operating system, such as Windows or UNIX, for example. Client and server software may be written in any programming language, such as C, C++, Java or Visual Basic, for example. The handheld device 100 may be a mobile phone, a laptop, a personal digital assistant (PDA), or other portable device. For some embodiments of the present invention, the handheld device 100 may be a WiFi® capable device, which may be used to access the network for data or by voice using voice over internet protocol (VOIP). The handheld device 100 may include a transceiver 102 to send and receive data over the network.

The handheld device 100 may include a controller or processor 104 that executes stored programs. The controller or processor 104 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The handheld device 100 may also include a volatile memory 106 and a non-volatile memory 108 to be used by the processor 104. The volatile 106 and nonvolatile data memory storage 108 may include one or more electrical, magnetic or optical memories such as a random access memory (RAM), cache, hard drive, or other memory device. The memory may have a cache to speed access to specific data. The memory may also be connected to a compact disc—read only memory (CD-ROM), digital video disc—read only memory (DVD-ROM), DVD read write input, tape drive or other removable memory device that allows media content to be directly uploaded into the system.

The handheld device 100 may include a user input interface 110 that may comprise elements such as a keypad, display, touch screen, or any other device that accepts input. The handheld device 100 may also include a user output device that may comprise a display screen and an audio interface 112 that may comprise elements such as a microphone, earphone, and speaker. The handheld device 100 also may include a component interface 114 to which additional elements may be attached, for example, a universal serial bus (USB) interface or an audio-video capture mechanism. Finally, the handheld device 100 may include a power supply 116.

Client software and databases may be accessed by the controller or processor 104 from the memory, and may include, for example, database applications, word processing applications, video processing applications as well as components that embody the decision support functionality of the present invention. The user access data may be stored in either a database accessible through a database interface or in the memory. The handheld device 100 may implement any operating system, such as Windows or UNIX, for example. Client and server software may be written in any programming language, such as ABAP, C, C++, Java or Visual Basic, for example.

A mobile computing device (MCD) 100 may download a virtual machine application to be executed on the MCD 100. The MCD 100 may be running a Java® Micro Edition (ME) with a mobile information device profile (MIDP) specification, allowing it to use mobile information device (MID) virtual machine applications called MIDlets. By using electronically signed certificates with the MIDlets, the MCD 100 may be assured of a higher level of security on the machine. Unsigned MIDlets may be used, but may be granted a lower level of access to various functions of the MCD 100.

The security of the MIDlet may be further increased by limiting the availability of a native function of the MCD 100 to the MIDlet, such as an application programming interface (API). A MCD 100 may improve security while using a MIDlet by employing a secure domain, a set of permissions regarding various functions or APIs that may be assigned to a MIDlet. The secure domains may have an allowed permission, granting unfettered access to an API; user permission, granting access upon user approval; or denial, barring the MIDlet from using that API. The user permissions may be set at various level of interaction modes, such as blanket, wherein the MIDlet has access to that API for the length of installation; session, wherein the MIDlet has access to that API for as long as the MIDlet is running; or one shot, wherein the MIDlet must ask permission for each use of the API.

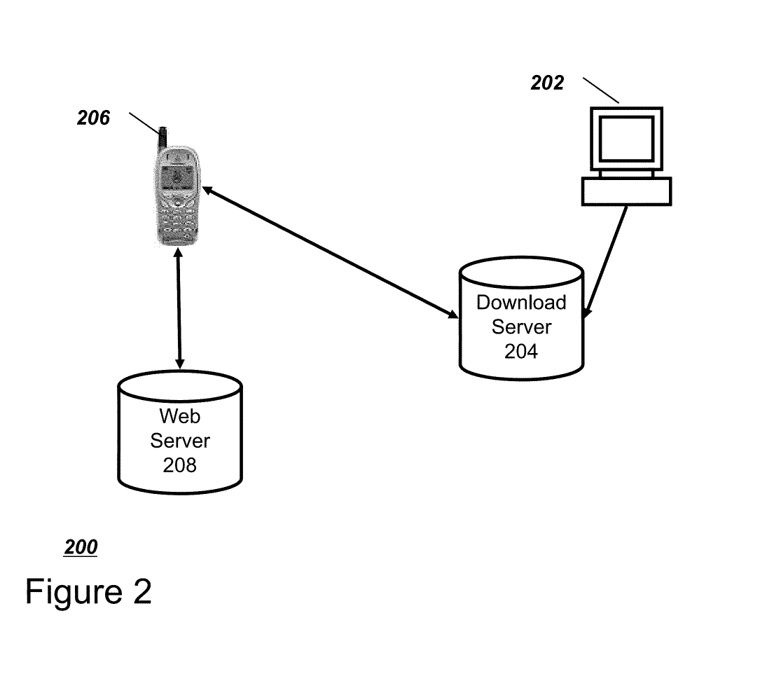

FIG. 2 illustrates in a block diagram one embodiment of a system 200 for downloading a virtual machine application to a mobile computing device. A developer 202 may create a virtual machine application, or MIDlet, and attach a signed electronic certificate. The developer 202 may transfer the virtual machine application to a download center 204. A user 206 may request a download of the virtual machine application from the download center 204. The download center 204 may download the virtual machine application to a handheld device 100 of the user 206. The user may then send an installation status report to the download center 204. The user 206 may then verify the signature of the certificate and install the virtual machine application on the handheld device 100. The user 206 may then use the virtual machine application, possibly in interaction with a web server 208.

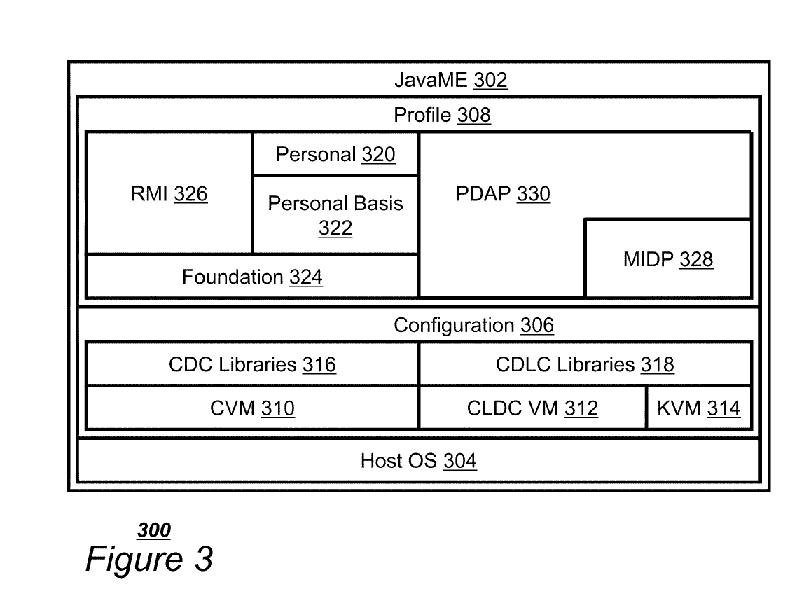

FIG. 3 illustrates in a block diagram one embodiment of a software configuration 300 of a MCD 100, such Java ME® 302. A MCD 100 may run a host operating system 302 as a basis for implementing all other software applications. The host operating system 302 may be used in conjunction with a configuration 304 and profile 306 to run the various virtual machine applications. The configuration 304 may include a coherent virtual machine (CVM) 310, a connected limited device configuration (CLDC) virtual machine (VM) 312, and a kilobyte virtual machine (KVM) 314. A connected device configuration (CDC) library 316 may support a CVM 310, while a CLDC library 318 may support the CLDC VM 312 and the KVM 314. The profile 308 may include personal profile 320 and a personal basis profile 322. The personal basis profile 322 may be a subset of the personal profile 320. Both the personal profile 320 and the personal basis profile 322 may be based on a foundation profile 324. The profile 308 may include a remote method invocation profile 326. The profile 308 may further include a MIDP 328 with access to a portable data acquisition package (PDAP) 330.

The use of such a configuration may create a greater flexibility with which to use a MCD 100. Secure domains may be used to control the access that MIDlets downloaded onto MCD 100 may have to various APIs. These secure domains may be expanded to take into account environmental factors. One such factor that may be used to adjust a secure domain on a continuing basis is location. Other environmental factors that may be used to determine the scope of a secure domain include communication signal strength, communication signal encryption strength, device temperature, power level, or other environmental factors that may have an effect on the security or stability of the device as the MIDlet uses the API.

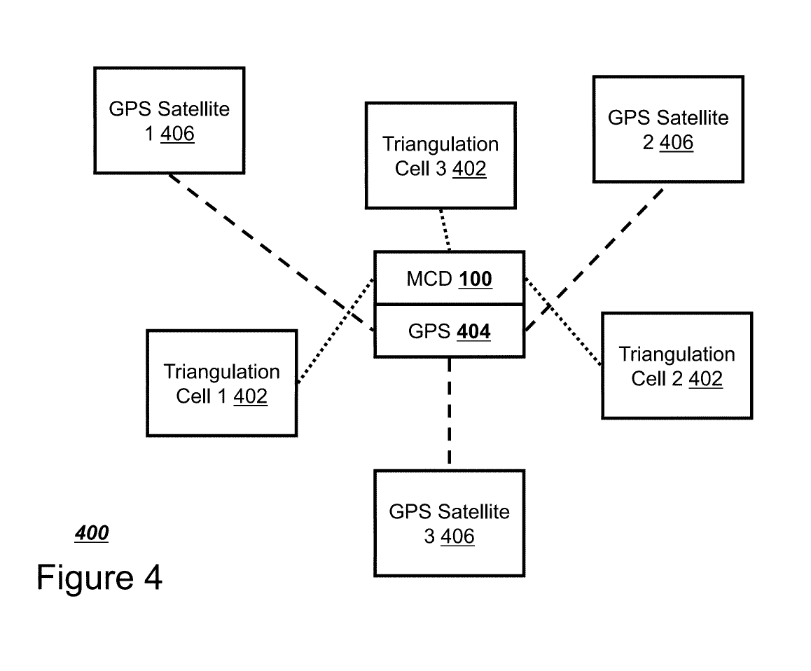

A sensor may be used to determine if the correct environmental factor is present for the MIDlet to be present in the secure domain, using a specified API. For example, a positioning mechanism may be integrated into a MCD 100, particularly through the component interface 114. FIG. 4 illustrates in a block diagram one embodiment of a system 400 for locating a MCD 100. An MCD 100 that is in regular contact with telecommunication cells 402 may use those cells to triangulate a position for the MCD 100. Additionally, a global positioning system (GPS) locator device 404 connected to the component interface 114 of the MCD 100 may connect with GPS satellites 406 to determine a position of the MCD 100.

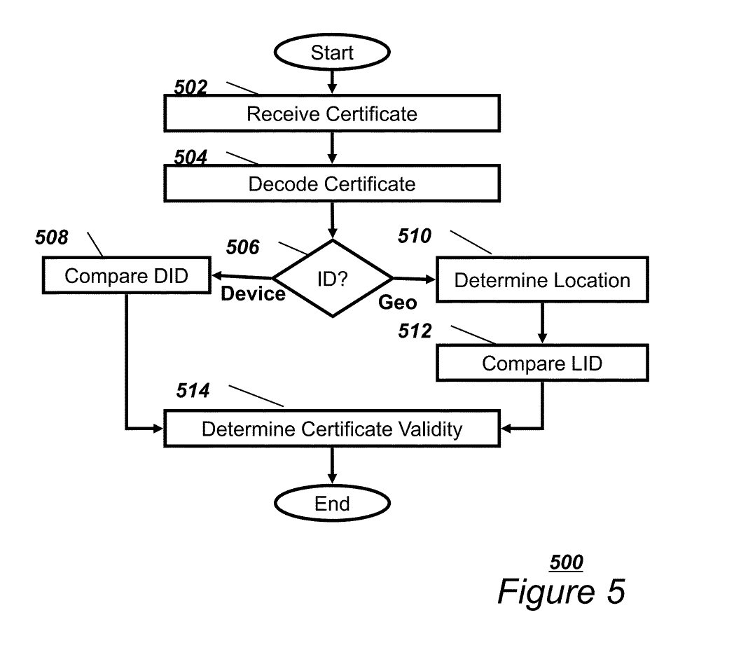

FIG. 5 illustrates in a flowchart one embodiment of a method 500 for certifying a virtual machine application for a mobile computing device based on location. A MCD 100 may receive a certificate associated with a VM application (VMA), or MIDlet, upon the downloading of the VMA (Block 502). The MCD 100 may decode the certificate (Block 504). The certificate may include an identifier (ID). The ID may be device specific to bind the VMA to a specific device, or location specific to bind use of the VMA to specific location. If the ID is a device specific ID (Block 506), the MCD 100 may compare the device ID (DID) to the ID of the MCD 100 (Block 508). If the ID is a location specific ID (Block 506), the MCD 100 may determine the location of the MCD 100 (Block 510). The MCD 100 may compare the location ID (LID) to the location of the MCD 100 (Block 512). The MCD 100 may use these comparisons to determine the validity of the certificate for that device (Block 514).

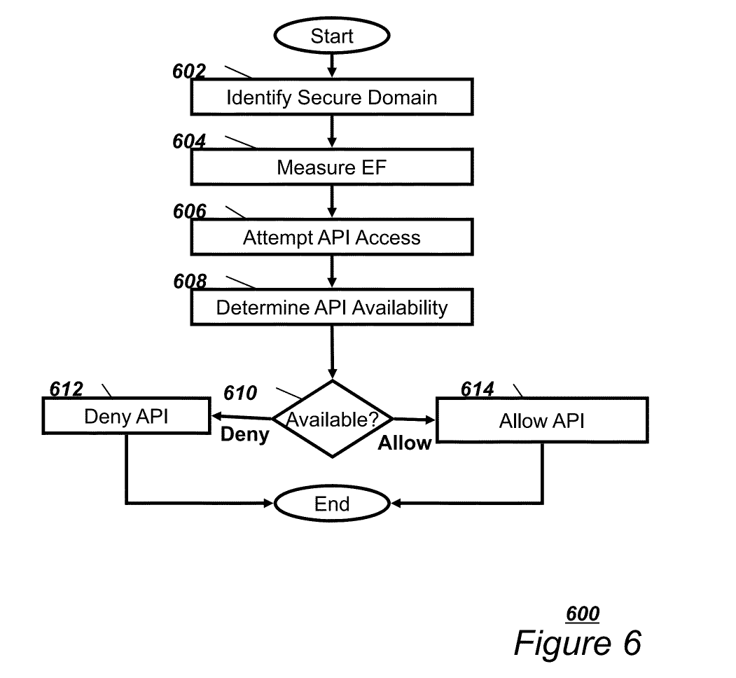

FIG. 6 illustrates in a flowchart one embodiment of a method 600 for controlling access to an application programming interface based on location. Upon receiving the certificate associated with the VMA, the MCD 100 may identify the secure domain for that VMA (Block 602). The secure domain being contingent upon an environmental factor of the MCD 100, the MCD 100 may measure the environmental factor (EF), such as the location, of the MCD 100 (Block 604). The VMA running on the MCD 100 may seek to access an API or other function (Block 606). The MCD 100 may determine the availability of the API based upon the measurement of an environmental factor of the device (Block 608). An API may be removed from a secure domain if a specified environmental factor, such as correct geographic location, is present or added to a secure domain in others. If the API is not available (Block 610), the MCD 100 may deny the VMA the use of that API (Block 612). If the API is available (Block 610), the MCD 100 may allow the VMA the use of that API (Block 614).

Embodiments may also be practiced in distributed computing environments where tasks are performed by local and remote processing devices that are linked (either by hardwired links, wireless links, or by a combination thereof) through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the electronic devices each processing the content in various possible ways. It does not necessarily need to be one system used by all end users. Accordingly, the appended claims and their legal equivalents should only define the invention, rather than any specific examples given.

We claim:

1. A method for location bound secure domains in a mobile client device, comprising:
identifying a secure domain for a mobile client device;
determining the geographic location of the mobile client device; and
limiting the availability of a native function on the device based on the geographic location.

2. The method of claim 1, wherein the mobile client device can obtain an allowed permission by which unfettered access to an API is permitted based upon the geographic location of the mobile client device.

3. The method of claim 1, wherein the mobile client device further includes a selective user permission, granting access upon user approval, in a secure domain.

4. The method of claim 1, wherein the mobile client device further includes a selective user permission, in a secure domain, barring access to an API upon access denial.

5. The method of claim 1, further comprising multiple interaction modes, including access to an API for the length of installation.

6. The method of claim 1, further comprising multiple interaction modes, including access to an API for a limited predetermined period of time.

7. The method of claim 1, further comprising multiple interaction modes, including a mode requiring permission request for each use of the API.

8. A telecommunications apparatus with secure operation based on geography, comprising:
a positioning mechanism that determines a geographic location for the telecommunications apparatus; and
a processor that identifies a secure domain and determines an availability of an application programming interface for the based on the geographic location, wherein at certain geographic locations access to the application programming interface is restricted, and at other geographic locations access to the application programming interface is unrestricted.

9. The telecommunications apparatus of claim 8, wherein the processor is operable to provide an allowed permission by which unfettered access to an API is permitted based upon the geographic location of the mobile client device.

10. The telecommunications apparatus of claim 8, wherein the processor is operable to provide a selective user permission, granting access only upon user approval, in a secure domain.

11. The telecommunications apparatus of claim 8, further comprising
wherein the mobile client device further includes a selective user permission mode, in a secure domain, barring access to an API upon user denial.

12. The telecommunications apparatus of claim 11, wherein the processor permits access to an API for the length of installation.

13. The telecommunications apparatus of claim 11, wherein the processor permits access to an API for a limited predetermined period of time.

14. The telecommunications apparatus of claim 8, wherein the processor requires permission request for each use of the API in a secure domain.
